(19) United States
(12) Patent Application Publication
(10) Pub. No.: US 2010/0235554 A1
(43) Pub. Date: Sep. 16, 2010

(54) RECONFIGURABLE POINT-TO-POINT MEMORY INTERFACE

(75) Inventors: Kun Yung Chang, Los Altos, CA (US); Richard E. Perego, Thornton, CO (US); Fariborz Assaderaghi, Los Altos, CA (US)

Correspondence Address: PVF -- RAMBUS, INC.;c/o PARK, VAUGHAN & FLEMING, LLP, 2820 FIFTH STREET, DAVIS, CA, 95618-7759, US

(73) Assignee: RAMBUS INC., Los Altos, CA (US)

(21) Appl. No.: 12/679,461

(22) PCT Filed: Sep. 5, 2008
(86) PCT No.: PCT/US08/75342

§ 371 Date: Mar. 22, 2010

(30) Foreign Application Priority Data
Sep. 5, 2008 (US) PCT/US2008/075342

(51) Int. Cl. G06F 13/14

(52) U.S. Cl. 710/104; 710/305

(57) ABSTRACT

Embodiments of an apparatus are described. An interface circuit in this apparatus receives or transmits digital signals on a bus and is configured to alternatively operate as either a data-bus interface circuit or a control-bus interface circuit in dependence upon a mode setting stored in a register. For example, the interface circuit may be pre-configured to interpret a line of an external bus as either a data line or a control line in accordance with the stored mode setting. Moreover, the stored mode setting may be dynamically configured (e.g., reprogrammed) during operation of the interface circuit so that subsequent digital signals are subsequently handled in accordance with a new mode setting.

### TECHNICAL FIELD

The present embodiments relate to the design of memory systems. More specifically, the present embodiments relate to circuits and methods for reconfiguring a memory interface in a memory controller to communicate commands or data between the memory controller and a memory device in a memory system.

### BRIEF DESCRIPTION OF THE FIGURES

FIG. 1 is a block diagram illustrating an embodiment of a memory system.

FIG. 2A is a block diagram illustrating an embodiment of a memory controller.

FIG. 2B is a block diagram illustrating an embodiment of a transceiver.

FIG. 3A is a block diagram illustrating an embodiment of a memory system.

FIG. 3B is a block diagram illustrating an embodiment of a memory system.

FIG. 4 is a flow chart illustrating an embodiment of a process for configuring an interface.

FIG. 5 is a block diagram illustrating an embodiment of a system. Table 1 provides configurations for several embodiments of a memory system.

Note that like reference numerals refer to corresponding parts throughout the drawings.

### DETAILED DESCRIPTION

The following description is presented to enable any person skilled in the art to make and use the disclosed embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present description. Thus, the present description is not intended to be limited to the embodiments shown, but is to be accorded the widest scope consistent with the principles and features disclosed herein.

Embodiments of an apparatus are described. An interface circuit in this apparatus receives or transmits digital signals on a bus and is selectively configured to operate as either a data-bus interface circuit or a control-bus interface circuit in dependence upon a mode setting stored in a register. For example, the interface circuit may be pre-configured to interpret a digital signal as either a data line or a control line in accordance with the stored mode setting, and accordingly, to route communications between an external bus and a local data bus or control bus internal to the apparatus. Moreover, the stored mode setting may be dynamically configured during operation of the interface circuit (i.e., reprogrammed) so that subsequent digital signals are thereafter handled in accordance with a new mode setting.

The apparatus may be included in an integrated circuit, such as a memory-controller integrated circuit or a memory-device integrated circuit.

In some embodiments, the bus is a system bus (e.g., the external bus) and the apparatus is a device that includes the local (or internal) data bus. The register may store multiple mode settings, including a first mode, in which the interface circuit acts as a data-bus interface circuit (and treats an external link as a data bus line), and a second mode, in which the interface circuit acts as a control-bus interface circuit (and treats the external link as a control line) and routes at least one of address or command information between the external bus and control logic internal to the device. From an external perspective, depending on mode, at least one pin associated with the apparatus and used for external communications is configured to act as either a data bus pin or a control pin in dependence upon the mode setting. Moreover, based on the mode setting, the interface circuit may be configured for alternative unidirectional or bidirectional communication (e.g., the interface circuit may be configured to bidirectionally handle data communications and to unidirectionally handle memory address commands).

The mode setting may be used to reassign a pin so that it may alternatively be used (a) as a data input/output (“I/O”) pin or an address pin, (b) as an address pin or another (non-address) type of control pin (e.g., to receive a clock signal, as a data mask pin, or for some other control information), or (c) for some other programmable configuration.

In some embodiments, the apparatus includes multiple reconfigurable interface circuits, each one of which is coupled to a corresponding line of an external bus to perform at least one of the receiving or transmitting digital signals onto the corresponding line. A mode setting for each of the multiple interface circuits may be stored either in a single register, or in multiple registers, such that multiple pins associated with the apparatus may be adapted for alternative use either as data pins or control pins. For example, in one implementation, a block of pins may be programmed in common for use either as data pins or control pins; alternatively, depending upon the implementation, each of several pins may be individually assigned duty as either a data pin or a control pin.

Another embodiment provides a method, which may be performed by the apparatus. During operation, the apparatus reads a control setting that indicates one of multiple mode settings. Then, the apparatus configures an interface circuit internal to the apparatus, which is responsive to the control setting, to be a selective one of a data-bus interface circuit or a control-bus interface circuit. This configuration may include configuring routing within the apparatus to couple either data or control signals, depending on the mode setting. The control setting may be programmed during initialization or device start up, and this configuration may be changed during operation of the device, for example, in accordance with an operating system mode, user software, or some other system preference. If desired, the control setting may be used to configure the apparatus for use with multiple signaling platforms, for example, to permit a memory device to operate in either of two dissimilar systems.

Another embodiment provides another method, which may be performed by the apparatus. During operation, the apparatus programs into a register a control setting that indicates one of multiple mode settings. Then, the apparatus operates an interface circuit internal to the apparatus, which is responsive to the control setting, to handle signals as either data signals or control signals, depending on the control setting. In this way, the interface circuit is pre-configured to act as either a data-bus interface circuit or a control-bus interface circuit in dependence upon the control setting.

Embodiments of the apparatus, integrated circuit, system and/or techniques may be used in or with different types of memory, including: volatile memory, non-volatile memory, DRAM, static random access memory (SRAM), read-only memory (ROM), erasable programmable read-only memory (EPROM), electrically erasable programmable read-only memory (EEPROM), Flash, solid-state memory, and/or another type of memory. Moreover, for a given type of memory, these techniques may be used in different memory technologies or technology generations (which may use different power supply voltages). For example, these techniques may be used in dual-data rate (DDR), graphics dual-data rate (GDDR) and/or synchronous DRAM, such as: DDR2, DDR3, DDRx, GDDR1, GDDR3, GDDR5, and/or Mobile DDR.

Consequently, memory components (such as the memory controller, the memory device, a memory module, and/or a memory system) that use these techniques may be included in a wide variety of applications, such as: desktop or laptop computers, computer systems, hand-held or portable devices (such as personal digital assistants and/or cellular telephones), set-top boxes, home networks, and/or video-game devices. For example, a storage device (such as the memory module) may be included in computer main memory. Moreover, one or more of these embodiments may be included in a communication channel, such as: serial or parallel links, metropolitan area networks, local area networks (LANs), and/or personal area networks (PANs).

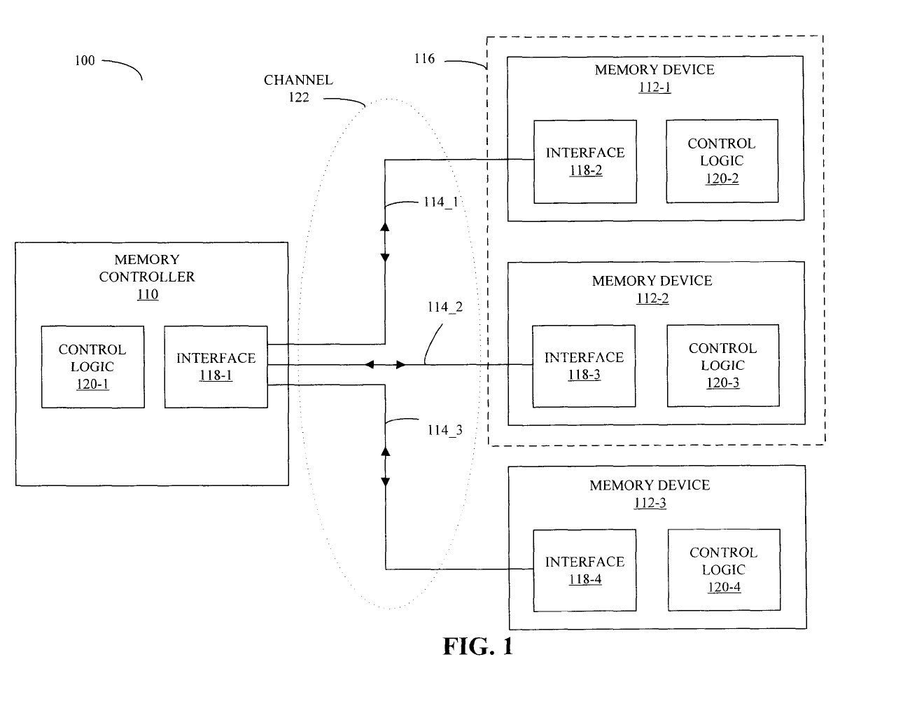

Embodiments of circuits, devices and systems to configure circuits in a memory interface will now be described in additional detail. FIG. 1 presents a block diagram illustrating an embodiment of a memory system 100. This memory system includes at least one memory controller 110 and one or more memory devices 112, such as one or more memory modules. While FIG. 1 illustrates memory system 100 having one memory controller 110 and three memory devices 112, other embodiments may have additional memory controllers and fewer or more memory devices 112. Moreover, while memory system 100 illustrates memory controller 110 coupled to multiple memory devices 112, in other embodiments two or more memory controllers may be coupled to one another. Note that memory controller 110 and one or more of the memory devices 112 may be implemented on the same or different integrated circuits, and that these one or more integrated circuits may be included in a chip-package.

In some embodiments, the memory controller 110 is a local memory controller (such as a DRAM memory controller) and/or is a system memory controller (which may be implemented in a microprocessor).

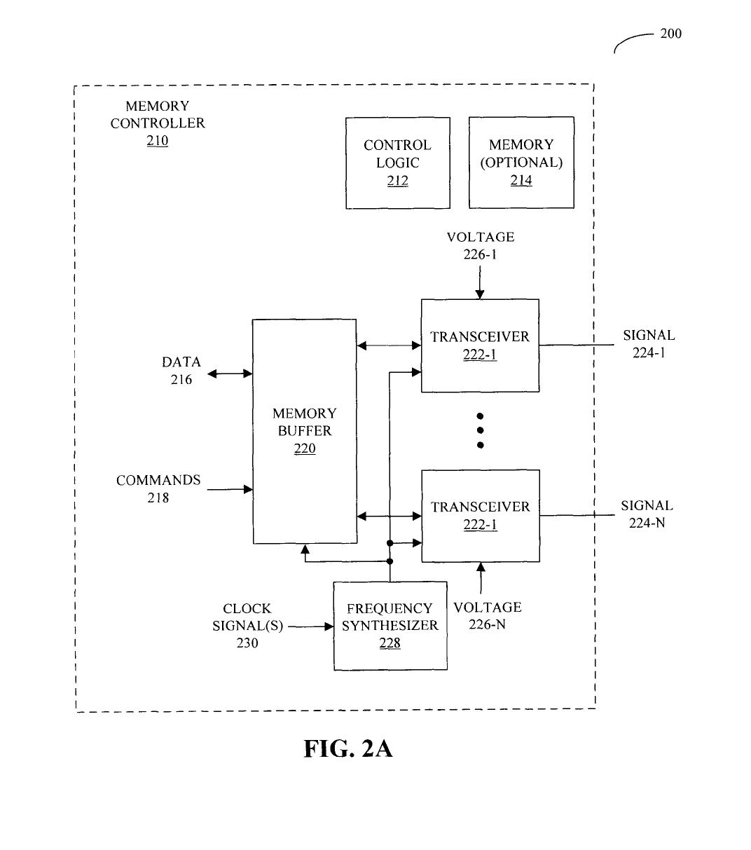

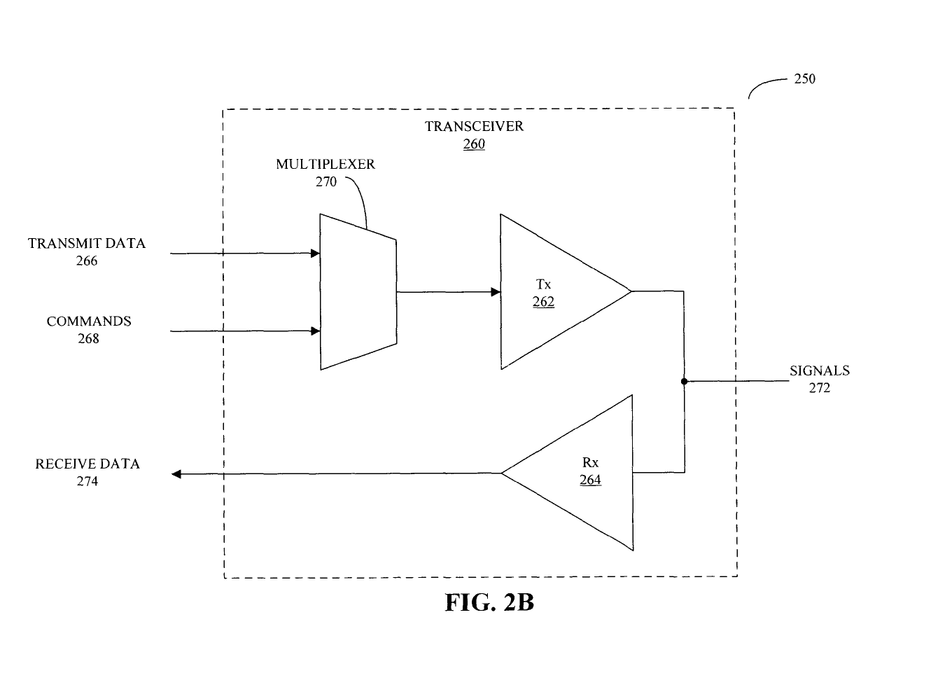

Memory controller 110 may include an I/O interface 118-1 and control logic 120-1. As discussed further below with reference to FIGS. 2A and 2B, control logic 120-1 may be used to reconfigure given circuits in the interface 118-1 to either transmit commands to one or more of the memory devices 112 or to communicate data to and/or from one or more of the memory devices 112. Note that this reconfiguration may be performed once, during an initialization mode of operation (i.e., statically), and/or during a normal mode of operation (i.e., dynamically).

In some embodiments, one or more of memory devices 112 optionally include control logic 120 and at least one of interfaces 118. However, in some embodiments some of the memory devices 112 may not have control logic 120. Moreover, memory controller 110 and/or one or more of memory devices 112 may include more than one of the interfaces 118, and these interfaces may share one or more control logic 120 circuits. Note that in embodiments two or more of the memory devices 112, such as memory devices 112-1 and 112-2, may be configured as a memory bank 116.

Memory controller 110 and memory devices 112 are coupled by one or more links 114 in a channel 122. While memory system 100 illustrates three links 114, other embodiments may have fewer or more links 114. Consequently, in some embodiments there is only one link. These links may include: wired and/or optical communication. Furthermore, links 114 may be used for bi-directional and/or uni-directional communications between the memory controller 110 and one or more of the memory devices 112. For example, bi-directional communication between the memory controller 110 and a given memory device may be simultaneous (full-duplex communication). Alternatively, the memory controller 110 may transmit information (such as a data packet which includes a command) to the given memory device, and the given memory device may subsequently provide requested data to the memory controller 110, i.e., a communication direction on one or more of the links 114 may alternate (half-duplex communication). Note that one or more of the links 114 and corresponding transmit circuits and/or receive circuits may be dynamically configured, for example, by one of the control logic 120 circuits, for bi-directional and/or unidirectional communication.

Signals corresponding to data and/or commands (such as commands) may be communicated on one or more of the links 114 using either or both edges in one or more timing signals. (As noted previously and discussed further below with reference to FIGS. 2A and 2B, in some embodiments circuits in the memory controller 110 associated with one or more of the links 114 may be reconfigured to communicate commands or data.) These timing signals may be generated based on one or more clock signals, which may be generated on-chip (for example, using a phase-locked loop and one or more reference signals provided by a frequency reference) and/or off-chip. Moreover, in some embodiments, transmitting and receiving of these signals may be synchronous and/or asynchronous.

Moreover, data may be communicated on one or more of the links 114 using one or more sub-channels associated with one or more carrier frequencies f. Moreover, a given sub-channel may have an associated: range of frequencies, a frequency band, or groups of frequency bands (henceforth referred to as a frequency band). For example, a baseband sub-channel is associated with a first frequency band and a passband sub-channel is associated with a second frequency band. Note that, if at least one of the links 114 is AC-coupled, the baseband sub-channel may not contain DC (i.e., does not include 0 Hz).

In some embodiments, frequency bands for adjacent sub-channels may partially or completely overlap, or may not overlap. For example, there may be partial overlap of neighboring frequency bands, which occurs in so-called approximate bit loading. Moreover, in some embodiments signals on adjacent sub-channels may be orthogonal.

Signals carried on these sub-channels may be time-multiplexed, frequency multiplexed, and/or encoded. Thus, in some embodiments the signals are encoded using: time division multiple access, frequency division multiple access and/or code division multiple access. Moreover, in some embodiments signals are communicated on the links 114 using discrete multi-tone communication (such as Orthogonal Frequency Division Multiplexing).

Note that encoding should be understood to include modulation coding and/or spread-spectrum encoding, for example, coding based on binary pseudorandom sequences (such as maximal length sequences or m-sequences), Gold codes and/or Kasami sequences. Furthermore, modulation coding may include bit-to-symbol coding in which one or more data bits are mapped together to a data symbol, and symbol-to-bit coding in which one or more symbols are mapped to data bits. For example, a group of two data bits can be mapped to: one of four different amplitudes of an encoded data signal; one of four different phases of a sinusoid; or a combination of one of two different amplitudes of a sinusoid and one of two different phases of the same sinusoid (such as in quadrature amplitude modulation or QAM).

In general, the modulation coding may include: amplitude modulation, phase modulation and/or frequency modulation, such as pulse amplitude modulation (PAM), pulse width modulation and/or pulse code modulation. For example, the modulation coding may include: two-level pulse amplitude modulation (2-PAM), four-level pulse amplitude modulation (4-PAM), eight-level pulse amplitude modulation (8-PAM), sixteen-level pulse amplitude modulation (16-PAM), two-level on-off keying (2-OOK), four-level on-off keying (4-OOK), eight-level on-off keying (8-OOK), and/or sixteen-level on-off keying (16-OOK).

In some embodiments, the modulation coding includes non-return-to-zero (NRZ) coding. Moreover, in some embodiments the modulation coding includes two-or-more-level QAM. Note that the different sub-channels communicated on the links 114 may be encoded differently and/or the modulation coding may be dynamically adjusted, for example, based on a performance metric associated with communication on one or more of the links 114. This performance metric may include: a signal strength (such as a signal amplitude or a signal intensity), a mean square error (MSE) relative to a target (such as a detection threshold, a point in a constellation diagram, and/or a sequence of points in a constellation diagram), a signal-to-noise ratio (SNR), a bit-error rate (BER), a timing margin, and/or a voltage margin.

In some embodiments, commands are communicated from the memory controller 110 to one or more of the memory devices 112 using a separate command link, i.e., using a subset of the links 114 which communicate commands. This separate command link may be wireless, optical and/or wired. However, in some embodiments commands are communicated using the same portion of the channel 122 (i.e., the same links 114) as data. (As noted previously and described further below with reference to FIGS. 2A and 2B, circuits in the memory controller 110 associated with one or more of the links 114 may be reconfigured to communicate commands or data.) Moreover, communication of commands: may have a lower data rate than the data rates associated with communication of data between the memory controller 110 and one or more of the memory devices 112; may use different carrier frequencies than are used to communicate data; and/or may use a different modulation technique than is used to communicate data.

Note that in some embodiments the memory controller 110 and/or one or more of the memory device 112 may use additional techniques to recover or prevent the loss of data communicated between components in the memory system 100 and/or the loss of stored data. For example, at least a portion of the data communicated between the components and/or the stored data may include error-detection-code (EDC) information and/or error-correction-code (ECC) information. This EDC and/or ECC information may be pre-existing or may dynamically generated (i.e., in real time).

In some embodiments, the ECC information includes a Bose-Chaudhuri-Hochquenghem (BCH) code. Note that BCH codes are a sub-class of cyclic codes. In exemplary embodiments, the ECC information includes: a cyclic redundancy code (CRC), a parity code, a Hamming code, a Reed-Solomon code, and/or another error checking and correction code.

Consequently, in some embodiments the receive circuits implement error detection and/or correction. For example, errors associated with communication may be detected by performing a multi-bit XOR operation in conjunction with one or more parity bits in the signals.

Moreover, control logic 120 in the memory controller 110 and/or one or more of the memory device 112 may take a variety of remedial actions in the event of an error or a degradation of one or more of the performance metrics during communication between the memory controller 110 and one or more of the memory devices 112. These remedial actions may include: re-transmitting previous data; transmitting previous or new data (henceforth referred to as data) using an increased transmission power than the transmission power used in a previous transmission; reducing the data rate in one or more of the sub-channels relative to the data rate used in a previous transmission; transmitting data with reduced intersymbol interference (for example, with blank intervals inserted before and/or after the data); adjusting a period of the one or more timing signals; adjusting a skew or delay of the one or more timing signals; transmitting data at a single clock edge (as opposed to dual-data-rate transmission); transmitting data with at least a portion of the data including ECC or EDC; transmitting data using a different encoding or modulation code than the encoding used in a previous transmission; transmitting data after a pre-determined idle time; transmitting data to a different receive circuit; transmitting data to another device (which may attempt to forward the data); and/or changing the number of sub-channels. Note that in some embodiments one or more of these adjustments are performed: continuously; as need based (for example, based on one or more of the performance metrics); and/or after a pre-determined time interval.

In some embodiments, the remedial action (and more generally adjustments to one or more of the sub-channels) is based on control information that is exchanged between the memory controller 110 and one or more of the memory devices 112. This control information may be exchanged using in-band communication (i.e., via the frequency bands used to communicate the signals corresponding to the data) and/or out-of-band communication (for example, using the separate link).

In some embodiments, the remedial action and/or adjustments involve an auto-negotiation technique. During this auto-negotiation technique, a receive circuit in one of the components (such as the memory controller 110) may provide feedback to a transmit circuit in another component (such as memory device 112-1) on the efficacy of any changes to the signals on a given sub-channel. Based on this feedback, the transmit circuit may further modify these signals, i.e., may perform the remedial action.

One problem in memory systems, such as memory system 100, is to provide signal integrity (such as acceptable values of one or more performance metrics) on links 114 as data rates increase. This problem may be addressed by using point-to-point links, each of which couple memory controller 110 to a given memory device and which offer high performance and reasonable device and system cost. However, using point-to-point links can increase the number of command links significantly.

Moreover, depending on the system architecture the number of command links may also vary considerably. For example, in graphics applications memory systems often have high aggregate data bandwidths (for the communication channel 122 or links 114) and low storage capacities, while in server applications memory systems often have high storage capacity and medium aggregate data bandwidths. In between these extremes, there are desktop and laptop applications with a wide range of configurations. Consequently, it is often difficult to design a component, such as a memory controller, that meets these divergent requirements, thereby facilitating memory system upgrades and/or allowing the component to be used in a variety of applications. This increases the cost of the component and/or results in the use of family of components to cover the various applications, which also increases expense.

A solution to this challenge is a memory controller having at least some reconfigurable transmit circuits or transceiver circuits. In the discussion that follows transceiver circuits are used as an illustrative example. These transceiver circuits include circuits that have more than one mode of operation. In particular, in one mode of operation a given circuit transmits commands, while in another mode of operation the given circuit transmits or receives data.

FIG. 2A presents a block diagram illustrating an embodiment 200 of a memory controller 210, such as the memory controller 110 (FIG. 1). Data 216 to be transmitted by the memory controller 210 to a memory device (such as one of the memory devices 112 in FIG. 1) is temporarily stored in memory buffer 220. Then, the data 216 is forwarded to transceivers 222, and is transmitted as (analog or digital) signals 224. Note that one or more of the transceivers 222 may be identical.

Similarly, signals 224 may be received from the memory device using transceivers 222, which include detection circuits (such as slicer circuits) to determine data 216 from the signals 224. In some embodiments, data 216 is temporarily stored in memory buffer 220.

Note that timing of the forwarding, receiving, and/or transmitting may be gated by one or more timing signals provided by frequency synthesizer 228. Consequently, signals 224 may be transmitted and/or received based on either or both edges in the one or more timing signals. Moreover, in some embodiments, transmitting and receiving may be synchronous and/or asynchronous.

These timing signals may be generated based on one or more clock signals 230, which may be generated on-chip (for example, using a phase-locked loop and one or more reference signals provided by a frequency reference) or off-chip. Moreover, voltage levels and/or a voltage swing of the signals 224 that are transmitted may be based on voltages 226 provided by a power supply (not shown), and logic levels of the data 216 that is received may be based on voltages 226 provided by the power supply. These voltages may be fixed or may be adjustable.

In some embodiments, a period of the one or more timing signals, a skew or delay of the one or more timing signals, and/or one or more of the voltages 226 are adjusted based on one or more performance metrics associated with communication to and/or from the memory controller 210.

While not shown in FIG. 2A, in some embodiments the memory controller 210 includes one or more additional transmit circuits coupled to a separate command link (or communication channel), which communicate commands 218 to the memory device. However, in some embodiments commands 218 are communicated using one or more of the transceivers 222.

Moreover, in some embodiments circuits in one or more of the transceivers 222 may be reconfigurable. In particular, control logic 212 may configure a mode of operation of a given transceiver, such as transceiver 222-1. In one mode of operation, the given transceiver communicates data 216 to and from the memory device through a given link (such as one of the links 114 in FIG. 1), and in another mode of operation the given transceiver communicates commands 218 (such as address information, or other forms of commands such as clock, mask, chip select or other forms of control signals) to and/or from the memory device through the given link.

In an exemplary embodiment, control logic in a system's host processor, such as control logic 212, detects or determines the number of installed memory devices during a ‘discovery phase’ during the boot or initialization sequence. This may be implemented in a variety of ways, including: the host processor may perform a register write/read operation to determine how many different memory devices uniquely respond; having one or more finite-state machines within each memory device sequence to a particular state depending upon their connection order and position in a chain; and/or having a ‘presence detect’ pin or signal for each memory device connected to a central hub and having the host processor or other control logic count the number of memory devices that are detected. Note that after the number of memory devices and any other relevant configuration parameters have been determined, the host processor can configure the desired number of command and data links for the system. Moreover, the transceivers and/or routing channels within a memory controller may then be configured via register operations (or an equivalent technique) based on the desired configuration.

Note that a current configuration or mode of operation of one or more of the transceivers 222 may be stored in optional memory 214. Moreover, note that the given link may be a point-to-point link between the memory controller 210 and the memory device.

In some embodiments, the mode of operation of the given transceiver is dynamically configured during normal operation of the memory controller 210. For example, dynamic configuration may facilitate dynamic adjustment of an aggregate data bandwidth value of the channel 122 (FIG. 1) to communicate data between the memory controller 210 and the memory device. However, in some embodiments the given transceiver is reconfigured during an initialization mode of operation (or power up, start up, etc.) and the configuration may be static during normal operation of the memory controller 210. This approach may allow the memory controller 210 to be reconfigured when components in a memory system are changed or modified.

By reconfiguring circuits in at least some of the transceivers 222, the memory controller 210 may support a wide variety of applications and/or may facilitate memory system upgrades. In particular, to obtain larger storage capacity, some of the transceivers 222 (and the associated links) can be configured to communicate commands 218 (such as commands), thereby allowing the memory controller 210 to communicate with more memory devices at the expense of a reduction in the aggregate data bandwidth. Similarly, in some embodiments some of the transceivers 222 (and the associated links) can be configured to communicate data 216, thereby increasing the aggregate data bandwidth at the expense of a reduction in the storage capacity (i.e., the number of memory devices coupled to the memory controller 210).

FIG. 2B presents a block diagram illustrating an embodiment 250 of a transceiver 260, such as one of the transceivers 222 (FIG. 2A). In this transceiver, data and commands (such as requests-for-data commands) can be handled interchangeably. In particular, in one mode of operation multiplexer 270 couples transmit data 266 to transmit circuit (Tx) 262, which outputs signals 272, and receive circuit (Rx) 264 receives signals 272 and detects receive data 274. Moreover, in another mode of operation multiplexer 270 couples commands 268 to transmit circuit (Tx) 262, which outputs signals 272. In this mode of operation, the receive circuit (Rx) 264 is not used (not activated). In this way, control logic 212 (FIG. 2A) may reconfigure transceiver 260 to communicate either data or commands on a given link.

In some embodiments, transceiver 260 (including the multiplexer 270) is implemented in a memory controller (such as memory controller 110 in FIG. 1 and/or memory controller 210 in FIG. 2A), in which case the transceivers in the memory controller may be identical. Note that this makes the memory controller symmetric in how data and commands are communicated, and facilitates testing during manufacturing. However, in some embodiments the multiplexer 270 may be implemented in an interface or physical layer, in which case only some of the transceivers in the memory controller may be identical.

While FIG. 2B illustrates a reconfigurable transceiver, note that in other embodiments the control and data/command paths which send information to the one or more transceivers may be reconfigured. In these embodiments, the one or more transceivers transmit whatever information they are provided (i.e., commands or data) when these transceivers are enabled to transmit. Similarly, in these embodiments the one or more transceivers receive whatever information arrives at their inputs when they are enabled to receive.

Note that the memory system 100 (FIG. 1), memory controller 210 (FIG. 2A), and/or transceiver 260 may include fewer components or additional components. For example, multiplexer 270 may be external to transceiver 260 (such as within a memory controller). Moreover, two or more components can be combined into a single component and/or the position of one or more components can be changed.

Components and/or functionality illustrated in memory system 100 (FIG. 1), memory controller 210 (FIG. 2A), and/or transceiver 260 may be implemented using analog circuits and/or digital circuits. Furthermore, components and/or functionality in the memory system 100 (FIG. 1), memory controller 210 (FIG. 2A), and/or transceiver 260 may be implemented using hardware and/or software. For example, control logic 212 may be included in a processor or a processor core.

This ability to reconfigure circuits in transceivers allows a given memory controller (such as memory controller 110 in FIG. 1 and/or memory controller 210 in FIG. 2A) to be used in a variety of applications and memory system architectures. In particular, this memory controller may be used in memory systems having N memory devices, where the memory systems include a range of storage capacity and where the channel 122 (FIG. 1) has a range of aggregate data bandwidth values to communicate data between the memory controller and the N memory devices.

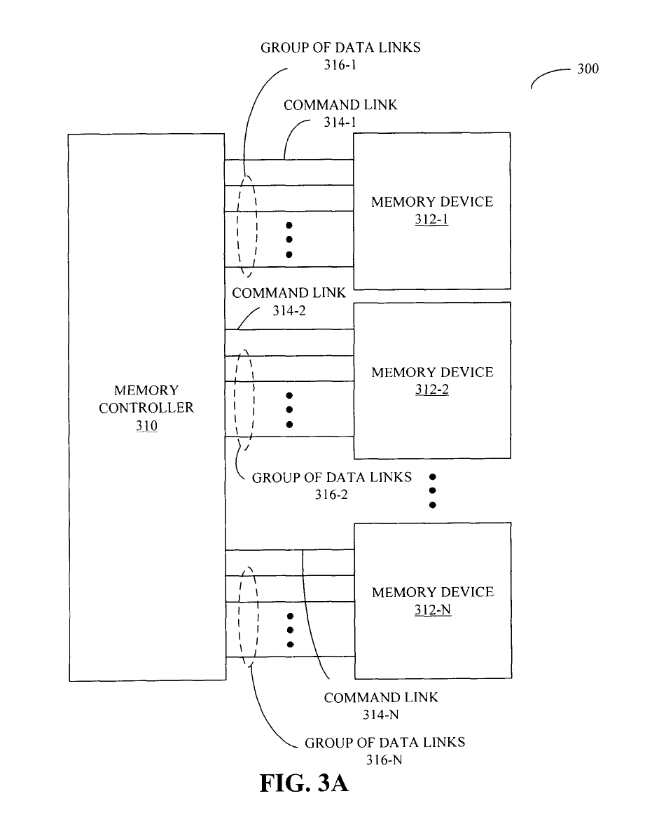

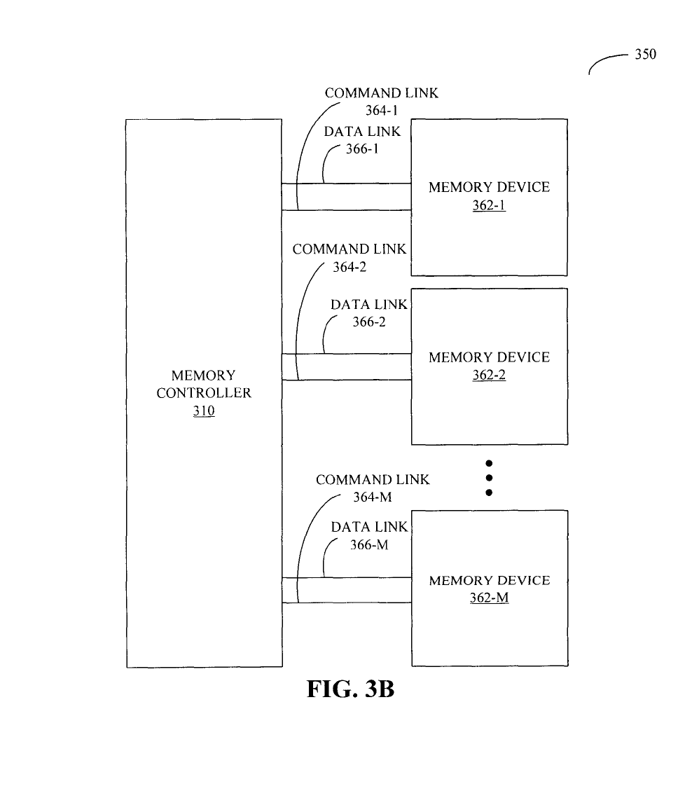

FIG. 3A presents a block diagram illustrating an embodiment of a memory system 300. This memory system includes a memory controller 310 coupled to N memory devices 312 by command links 314 and groups of data links 316. In particular, each of these memory devices is coupled to the memory controller 310 by one of the command links 314 (such as command link 314-1) and a group of data links (such as group of data links 316-1). Note that the number of data links in a given group of data links may be 1, 2, 4, 8, 16, or 32.

In contrast, FIG. 3B presents a block diagram illustrating an embodiment of a memory system 350 in which the memory controller 310 is coupled to M memory devices 362 by command links 364 and data links 366. In particular, each of these memory devices is coupled to the memory controller 310 by one of the command links 364 (such as command link 364-1) and one of the data links 366 (such as data link 366-1).

While memory systems 300 (FIG. 3A) and 350 have been illustrated with a single command link (such as command link 364-1) between the memory controller 310 and a given memory device (such as memory device 362-1), in other embodiments there may be two or more command links between the memory controller 310 and the given memory device.

Note that by reconfiguring transceivers in the memory controller 310, memory system 350 can accommodate a larger storage capacity (i.e., for a given memory device capacity, M is greater than N) than memory system 300 with a reduced aggregate data bandwidth. In an exemplary embodiment, the range of storage capacity is between 16 and 256 GB. Moreover, the range of aggregate data bandwidths may include values other than multiples of 2^{K}, where K is the number of memory devices (such as an integer in the range 1-128).

Table 1 provides configurations for several embodiments of a memory system, assuming a bandwidth of 16 Gb/s per data link and a storage capacity of 2 Gb per memory device. For example, in a memory system with eight memory devices, by configuring the transceivers in the memory controller to support eight point-to-point command links and 256 point-to-point data links each command link is coupled to a 32-bit wide memory device, the aggregate data bandwidth is 512 GB/s, and the storage capacity is 2 GB. Moreover, by reconfiguring 120 of the data transceivers in the same memory controller to support command links, the memory system will have 136 data links and 128 command links. This embodiment can support an aggregate data bandwidth of 256 GB/s and a storage capacity of 32 GB. Note that in this embodiment eight of the data links can be used as a group of point-to-point links or are unused.

TABLE 1

| | Number of | | Aggregate Data | Storage |
|---|---|---|---|---|
| Number of | Command | Number of | Bandwidth | Capacity |
| DataLinks | Links | Memory Devices | (GB/s) | (GB) |
| 256 | 8 | 8 | 512 | 2 |
| 128 | 128 | 128 | 256 | 32 |
| 128 | 16 | 16 | 256 | 4 |
| 128 | 32 | 32 | 256 | 8 |
| 128 | 64 | 64 | 256 | 16 |

Alternatively, by reconfiguring eight the data transceivers in this same memory controller to support command links, the memory system may have 16 command links and 248 data links. In this embodiment, 128 data links may be used as a memory interface, and the aggregate data bandwidth is 256 GB/s with a storage capacity of 4 GB. Note that the remaining 120 data links may be configured as a chip-to-chip interface (such as link FlexIO), which can provide a high aggregate data bandwidth (for example, to a graphics processor).

Note that in order to make board routing easier, the data and command transceivers in the memory devices may be grouped together on the memory-controller side. Moreover, command links may be spread out among the transceivers on the memory controller. For example, as illustrated in FIGS. 3A and 3B, a command link may be associated with a group of one or more data links, and this command link may be positioned between adjacent groups of data links. Also note that when reconfiguring the memory controller, transceivers associated with data links that are being converted to command links may be selected from transceivers associated with different groups of data links to prevent wiring congestion.

Thus, with reconfigurable command and data transceivers, a designer may design a memory controller for the highest performance (and lowest capacity). Moreover, this memory controller may be reconfigured (without redesign) for different memory system architectures and applications, thereby saving additional design and manufacturing expenses.

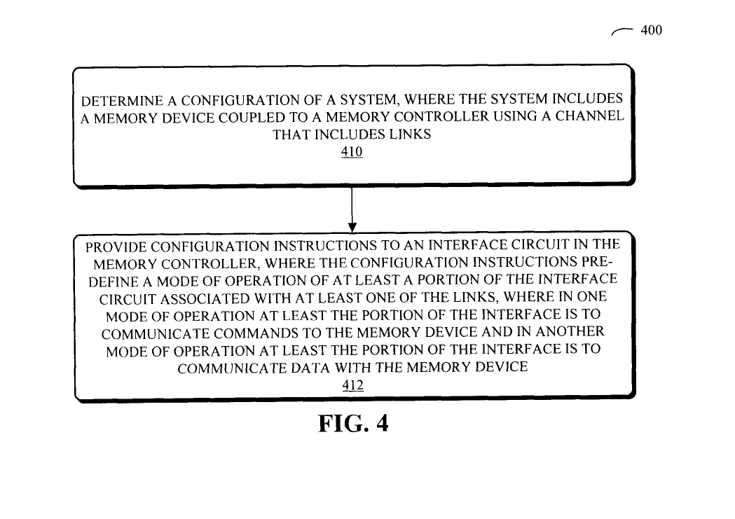

A process for configuring an interface will now be described, with reference to FIG. 4. FIG. 4 is a flow chart illustrating an embodiment of a process 400 for configuring an interface, which may be performed by a device (such as a memory controller). During operation, the device determines a configuration of a system (410), where the system includes a memory device coupled to a memory controller using a channel that includes links. For example, a memory controller (such as memory controller 310 in FIGS. 3A and 3B) measures electrical connections, determines a state of a fuse, or reads a value in a register for a given link in the channel 122 (FIG. 1). (The state of the fuse or the value in the register may be programmed by a controller or by software, for example, to take a multiplatform memory device and adapt it for use in one of several dissimilar platforms.) Next, the device provides configuration instructions to an interface circuit in the memory controller (412), where the configuration instructions pre-define a mode of operation of at least a portion of the interface circuit associated with at least one of the links, and where in one mode of operation at least the portion of the interface circuit communicates commands to the memory device and in another mode of operation at least a portion of the interface circuit communicates data with the memory device. In this way, at least the portion of the interface circuit can be pre-configured so that subsequent digital signals are handled either as data signals or control signals (such as commands or address signals).

In some embodiments of the process 400 there may be fewer or additional operations. Moreover, two or more operations can be combined into a single operation, and/or a position of one or more operations may be changed.

Devices and circuits described herein may be implemented using computer aided design tools available in the art, and embodied by computer-readable files containing software descriptions of such circuits. These software descriptions may be: at behavioral, register transfer, logic component, transistor and layout geometry-level descriptions. Moreover, the software descriptions may be stored on storage media or communicated by carrier waves.

Data formats in which such descriptions may be implemented include, but are not limited to: formats supporting behavioral languages like C, formats supporting register transfer level RTL languages like Verilog and VHDL, formats supporting geometry description languages (such as GDSII, GDSIII, GDSIV, CIF, and MEBES), and other suitable formats and languages. Moreover, data transfers of such files on machine-readable media including carrier waves may be done electronically over the diverse media on the Internet or, for example, via email. Note that physical files may be implemented on machine-readable media such as: 4 mm magnetic tape, 8 mm magnetic tape, 3½ inch floppy media, CDs, DVDs, and so on.

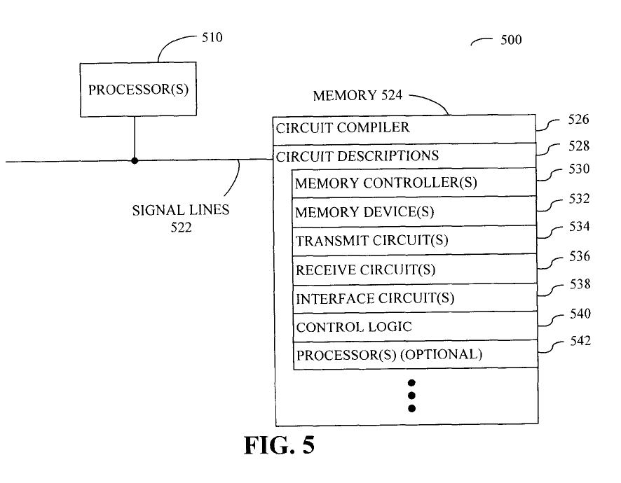

FIG. 5 presents a block diagram illustrating an embodiment of a system 500 that stores such computer-readable files. This system may include at least one data processor or central processing unit (CPU) 510, memory 524 and one or more signal lines or communication busses 522 for coupling these components to one another. Memory 524 may include high-speed random access memory and/or non-volatile memory, such as: ROM, RAM, EPROM, EEPROM, Flash, one or more smart cards, one or more magnetic disc storage devices, and/or one or more optical storage devices.

Memory 524 may store a circuit compiler 526 and circuit descriptions 528. Circuit descriptions 528 may include descriptions of the circuits, or a subset of the circuits discussed above with respect to FIGS. 2-3. In particular, circuit descriptions 528 may include circuit descriptions of: one or more memory controllers 530, one or more memory devices 532, one or more transmit circuits 534, one or more receive circuits 536, one or more interface circuits 538, control logic 540 (or a set of instructions), and/or one or more optional processors 542.

In some embodiments, system 500 includes fewer or additional components. Moreover, two or more components can be combined into a single component, and/or a position of one or more components may be changed.

The foregoing descriptions of embodiments have been presented for purposes of illustration and description only. They are not intended to be exhaustive or to limit the present description to the forms disclosed. Accordingly, many modifications and variations will be apparent to practitioners skilled in the art. Additionally, the above disclosure is not intended to limit the present description. The scope of the present description is defined by the appended claims.

What is claimed is:

1. An apparatus, comprising:
an interface circuit adapted to perform at least one of receiving or transmitting digital signals onto a line of a bus;
a register adapted to store a mode setting; and
configuration logic to configure the interface circuit in dependence upon the mode setting stored in the register;
wherein the interface circuit is configured to operate as either a data-bus interface circuit or a control-bus interface circuit in dependence upon the mode setting.

2. The apparatus of claim 1, wherein the register is adapted to be reprogrammed such that mode setting can be dynamically configured during operation of the interface circuit.

3. The apparatus of claim 1, embodied as one of a memory-controller integrated circuit or a memory-device integrated circuit.

4. The apparatus of claim 1, wherein:
the bus is a system bus;
the apparatus further comprises a local data bus;
the register is adapted to store multiple mode settings; and
the multiple mode settings include a first mode setting, in which the interface circuit acts as a data-bus interface circuit and routes data between the system bus and the local data bus, and a second mode setting, in which the interface circuit acts as a control-bus interface circuit and routes at least one of address or command information between the system bus and the configuration logic.

5. An integrated circuit, comprising:
an interface circuit adapted to perform at least one of receiving or transmitting digital signals onto a line of a bus; and
a register adapted to store a mode setting for the interface circuit, including a setting representing at least two modes including a first mode in which the interface circuit is configured as a data bus line, and a second mode in which the interface circuit is configured as a control line;
wherein at least one pin associated with the integrated circuit and used for external communications is configured to act as either a data bus pin or a control pin in dependence upon the mode setting.

6. The integrated circuit of claim 5, wherein the interface circuit is adapted to be configured, in dependence upon the mode setting, for alternative unidirectional or bidirectional communication.

7. The integrated circuit of claim 5, wherein the integrated circuit is embodied in a memory controller.

8. The integrated circuit of claim 5, wherein the integrated circuit is embodied in a memory device.

9. The integrated circuit of claim 5, further comprising:
multiple reconfigurable interface circuits, each one of which is coupled to a corresponding line of an external bus to perform at least one of the receiving or transmitting digital signals onto the corresponding line; and
at least one of the register or one or more additional registers are adapted to store the mode setting for each of the multiple interface circuits, so as to permit selection between at least the two modes including the first mode in which the associated interface circuit is configured as a data bus line, and the second mode in which the associated bus interface circuit is configured as a control line, to allow multiple pins associated with the integrated circuit to be adapted for alternative use either as data pins or control pins.

10. The integrated circuit of claim 5, wherein the interface circuit and internal routing are such that when the interface circuit is configured as a control line it operates as an address line.

11. The integrated circuit of claim 5, wherein the interface circuit and internal routing are such that when the interface circuit is configured as a control line it operates as a command line.

12. A method, comprising:
reading a control setting that indicates one of multiple mode settings; and
configuring an interface circuit internal to a chip responsive to the control setting to be a selective one of a data-bus interface circuit or a control-bus interface circuit, including configuring routing within the chip to couple either data or control signals, depending on the mode setting;
wherein the interface circuit is configured to act as either a data-bus interface circuit or a control-bus interface circuit in dependence upon the control setting.

13. An apparatus, comprising:
an interface circuit adapted to perform at least one of receiving digital signals from or transmitting digital signals onto a line of a bus; and
means for setting a mode of the interface circuit, to pre-configure the interface circuit to interpret signals as either data signals or control signals and thereby act as either a data-bus interface circuit or a control-bus interface circuit in dependence upon the mode.

14. The apparatus of claim 13, wherein the mode is dynamically configured during operation of the interface circuit to handle subsequently received signals in accordance with a dynamically set mode.

15. The apparatus of claim 13, embodied as one of a memory-controller integrated circuit or a memory-device integrated circuit.

16. An integrated circuit, comprising:
an interface circuit adapted to perform at least one of receiving or transmitting digital signals onto a line of a bus; and
a register adapted to store a mode setting for the interface circuit, to pre-configure the interface circuit to interpret a digital signal as either a data signal or a control signal in accordance with the stored mode setting,
wherein at least one pin associated with the integrated circuit and used for external communications is configured to act as either a data bus pin or a control pin in dependence upon the mode setting.

17. The integrated circuit of claim 16, wherein the interface circuit is adapted to be configured, in dependence upon the mode setting, for alternative unidirectional or bidirectional communications.

18. The integrated circuit of claim 16, wherein the integrated circuit is embodied in a memory controller.

19. The integrated circuit of claim 16, wherein the integrated circuit is embodied in a memory device.

20. The integrated circuit of claim 16, further comprising:
multiple reconfigurable interface circuits, each one of which is coupled to a corresponding line of an external bus to perform at least one of the receiving or transmitting digital signals onto the corresponding line; and
at least one of the register or one or more additional registers are adapted to store the mode setting for each of the multiple interface circuits, so as to permit selection between at least the two modes including a first mode in which the associated interface circuit is configured as a data bus line, and a second mode in which the associated bus interface circuit is configured as a control line, to allow multiple pins associated with the integrated circuit to be adapted for alternative use either as data pins or control pins.

21. The integrated circuit of claim 16, wherein the interface circuit and internal routing are such that when the interface circuit is configured as a control line it operates as an address line.

22. The integrated circuit of claim 16, wherein the interface circuit and internal routing are such that when the interface circuit is configured as a control line it operates as an command line.

23. A method, comprising:
programming into a register a control setting that indicates one of multiple mode settings; and
operating an interface circuit internal to an integrated circuit responsive to the control setting to handle signals as either data signals or control signals, depending on the control setting, wherein the interface circuit is pre-configured to act as either a data-bus interface circuit or a control-bus interface circuit in dependence upon the control setting.
